(19) United States
(12) Patent Application Publication
(10) Pub. No.: US 2014/0243139 A1
(43) Pub. Date: Aug. 28, 2014

(54) ASSEMBLY HAVING A BELT-PULLEY DRIVE

(71) Applicants: Michael Weiss, Herzogenaurach (DE); Klaus Hahn, Oberreichenbach (DE)

(72) Inventors: Michael Weiss, Herzogenaurach (DE); Klaus Hahn, Oberreichenbach (DE)

(73) Assignee: SCHAEFFLER TECHNOLOGIES GMBH & CO. KG, Herzogenaurach (DE)

(21) Appl. No.: 14/348,274

(22) PCT Filed: Mar. 12, 2012
(86) PCT No.: PCT/EP2012/054202

§ 371 Date: Mar. 28, 2014

(30) Foreign Application Priority Data
Sep. 30, 2011 (DE) 102011083802.3

(51) Int. Cl. F16H 37/02

(52) U.S. Cl. CPC F16H 37/02
USPC 475/210

(57) ABSTRACT

Assembly having a belt-pulley drive, having a pulley wheel which can be driven by a belt and is configured for transmitting a torque to a drive shaft of the assembly. The assembly has a switchable gear mechanism which makes a transmission ratio possible between the rotational speed of the pulley wheel and the rotational speed of the drive shaft.

### FIELD OF THE INVENTION

The invention relates to an assembly having a belt-pulley drive, having a belt pulley which can be driven by a belt and is configured for transmitting a torque to a drive shaft of the assembly.

### BACKGROUND

Belt drive systems are used in internal combustion engines, in order to drive different assemblies or auxiliary assemblies. Examples for assemblies of this type are a water pump, a generator of an auxiliary pump for the power steering system or an air conditioning system compressor. The drive takes place via a traction mechanism, in particular a drive belt, which is connected firstly directly or indirectly to the crankshaft of the internal combustion engine and secondly to the belt pulley.

Document U.S. Pat. No. 5,076,216 has disclosed a coolant pump for a vehicle, which coolant pump is driven by a belt drive. A direct, permanent coupling has the disadvantage that coolant is already pumped through cooling water ducts of the engine housing even in the case of a cold engine. The water pump therefore has a clutch, in order to interrupt the drive if required, in particular in the case of cold starting. The clutch is actuated electromagnetically and does not engage until a defined coolant temperature is reached. The actuators which are required for this use magnets, the size and mass of which are disadvantageous.

DE 10 2009 056 368 A1 has disclosed an assembly having a belt-pulley drive, which assembly has a switchable clutch, in order to decouple the assembly from the drive when it is not required.

These conventional assemblies afford the possibility of rotating the shaft of the assembly at the rotational speed of the crankshaft or, as an alternative, of the coupling said shaft.

The invention is therefore based on the object of specifying an assembly having a belt-pulley drive, which assembly can be adapted in an improved manner to different operating states.

### SUMMARY

In order to achieve this object, it is provided according to the invention in an assembly of the type which is mentioned at the outset that it has a switchable gear mechanism which makes a transmission ratio possible between the rotational speed of the belt pulley and the rotational speed of the drive shaft.

The invention provides an assembly which can be adapted in an improved manner to different operating states, by a switchable transmission ratio being provided between the crankshaft rotational speed and the rotational speed of the drive shaft of the assembly.

The invention is suitable, in particular, for assemblies having a switchable belt-pulley drive, having a belt pulley which can be driven by a belt, and a clutch which, in an engaged state, brings about a drive connection between the belt pulley and the drive shaft of the assembly and, in a non-engaged state, brings about a separation of the belt pulley from the drive shaft. This clutch is optional, however; as an alternative, the assembly according to the invention can also have a drive shaft which is connected fixedly to the belt pulley. In an assembly which has a clutch, a switchable gear mechanism is provided according to the invention, which switchable gear mechanism makes a transmission ratio possible between the rotational speed of the belt pulley and the rotational speed of the drive shaft.

In the context of the invention, it is particularly preferred that the switchable gear mechanism is a planetary gear mechanism. A gear mechanism of this type is distinguished by the fact that it can be integrated into an existing belt pulley or its mounting in a manner which is neutral in terms of installation space. Accordingly, a conventional assembly can be replaced with low outlay by an assembly according to the invention, in order to afford the possibility of it being possible to drive the drive shaft at two different rotational speeds.

According to one development of the assembly according to the invention, it can be provided that the belt pulley has an external toothing system which is in engagement with a plurality of planetary gears which in turn can be brought into engagement with a sun gear which can be connected or is connected to the drive shaft. The sun gear is therefore assigned to the drive shaft, the external toothing system is integrated into the belt pulley, and the planetary gears are situated between them and are meshed firstly with the external toothing system and secondly with the sun gear. This refinement is distinguished by a low installation space requirement.

It also lies within the scope of the invention that the assembly comprises a linear cam mechanism, in order to make a coupling of the drive shaft of the sun gear or the belt pulley possible. It can be provided in a further refinement of the invention that the linear cam mechanism comprises an axially displaceable section with an increased diameter, through which section balls are pressed into recesses in the case of a corresponding axial positioning, in order to produce a coupling between the belt pulley and the drive shaft or the planetary gear mechanism and the drive shaft. Here, a switching operation can be carried out by way of an axial adjustment of the linear cam shaft.

As an alternative, the assembly according to the invention can comprise a slider sleeve, in order to make a coupling of the drive shaft of the sun gear or the belt pulley possible. In an analogous manner to the shaft of the linear cam mechanism, the slider sleeve is axially adjustable, in order to carry out a switching operation.

The assembly according to the invention can have an actuator, in order to actuate the linear cam mechanism or the slider sleeve. The actuator can be actuated by a control unit.

The assembly according to the invention can be configured particularly advantageously as a water pump, hydraulic pump, compressor or generator.

### BRIEF DESCRIPTION OF THE DRAWINGS

One exemplary embodiment of the invention is shown in the drawing and will be described in greater detail in the following text. In the drawing:

FIG. 1 shows a section side view of a detail of an assembly in accordance with a first exemplary embodiment of the invention,

FIGS. 2 and 3 show further operating states of the assembly which is shown in FIG. 1,

FIG. 4 shows an axial view of the planetary gear mechanism of the assembly according to the invention,

FIG. 5 shows a detail of a sectioned side view of a second exemplary embodiment of an assembly according to the invention,

FIGS. 6 and 7 show further operating states of the assembly which is shown in FIG. 5,

FIG. 8 shows a detail of a side view of a further exemplary embodiment of an assembly according to the invention,

FIG. 9 shows the assembly which is shown in FIG. 8 in a further operating state, and

FIGS. 10 and 11 show a further exemplary embodiment of an assembly according to the invention.

### DETAILED DESCRIPTION OF THE PREFERRED EMBODIMENTS

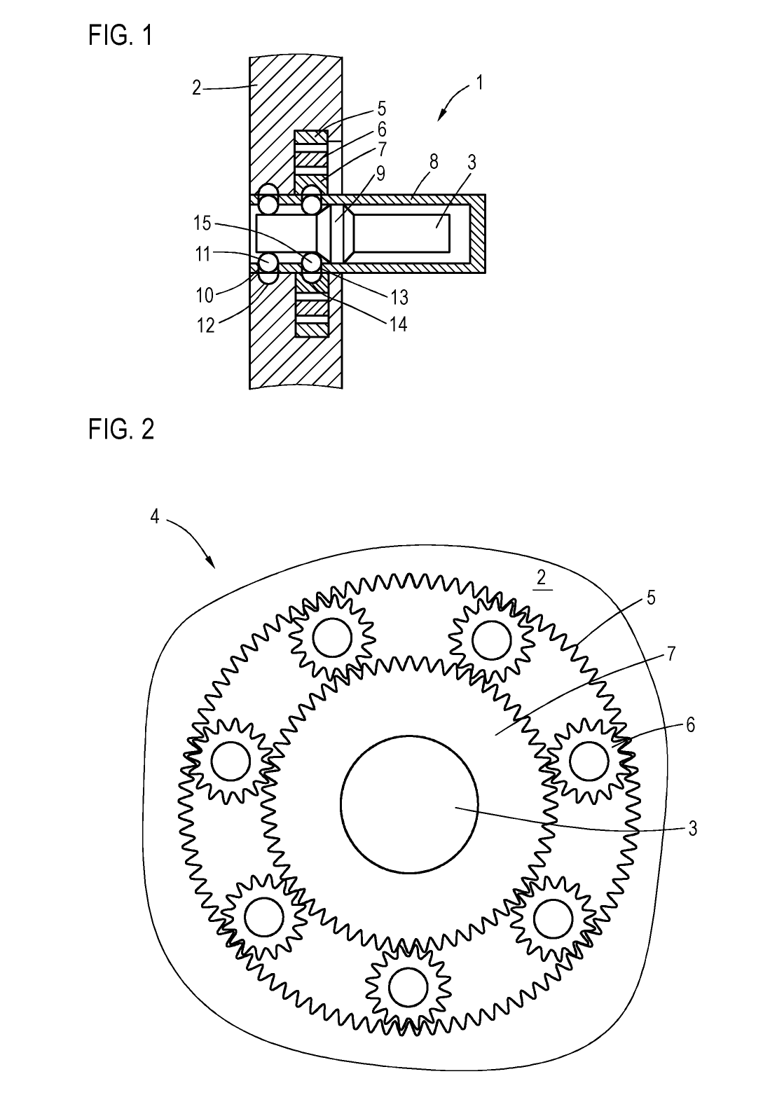

FIG. 1 shows a detail of the first sectioned side view of an assembly 1. The assembly is an auxiliary assembly of an internal combustion engine; in the present exemplary embodiment, the assembly 1 is configured as a water pump. The assembly could likewise be an air conditioning compressor, a generator, a hydraulic pump or the like.

Assemblies of this type have a belt-pulley drive with a belt pulley 2 which can be driven by a belt. On its outer circumference, the belt pulley 2 (pulley wheel) has a groove for a wraparound element (not shown) which is configured as a belt. The belt is connected to the crankshaft of an internal combustion engine, with the result that the belt pulley 2 is driven permanently when the internal combustion engine is running, the rotational speed of the belt pulley corresponding to the rotational speed of the crankshaft.

The assembly which is shown in FIG. 1 has a drive shaft 8, with the result that a torque can be transmitted from the driven belt pulley 2 to the drive shaft 8. The drive shaft 8 serves to drive the pump arrangement (not shown).

In an assembly which is configured as a water pump, it is desirable for it to be possible to engage or disengage the assembly as required, as a drive of the drive shaft 8 is undesired in many operating states. It is advantageous, for example, to switch off a water pump or decouple it from the drive during cold starting, until the coolant has reached a defined temperature. In this way, the warming-up operation of the internal combustion engine is accelerated and the exhaust gas characteristic is improved. When a defined temperature is reached, the drive shaft can be coupled to the belt pulley, with the result that the water pump delivers coolant. Assemblies such as water pumps have to be designed for the most unfavorable operating state, in which a high delivery rate is required. One example for an operating state of this type is an overloaded vehicle which is driving up a steep gradient at high external temperatures. Accordingly, the maximum output of the pump is correspondingly high, in order to ensure sufficient cooling even in the case of extraordinary operating states of this type. Secondly, said high delivery output is not required during normal operation. The assembly 1 which is shown in FIG. 1 therefore has a switchable gear mechanism which is configured as a planetary gear mechanism 4 and makes it possible to drive the drive shaft 8 at two different rotational speeds.

FIG. 2 is a view of the components of the planetary gear mechanism 4 in the axial direction. The belt pulley 2 has an external toothing system 5 which meshes with planetary gears 6. In the exemplary embodiment, seven planetary gears 6 are provided; the size and number of the planetary gears can be different, however, and are in accordance with the desired transmission ratio. The planetary gears 6 mesh secondly with the sun gear 7 which can be coupled to the drive shaft 8. The sun gear 7 is of hollow configuration and is guided radially on the drive shaft 8.

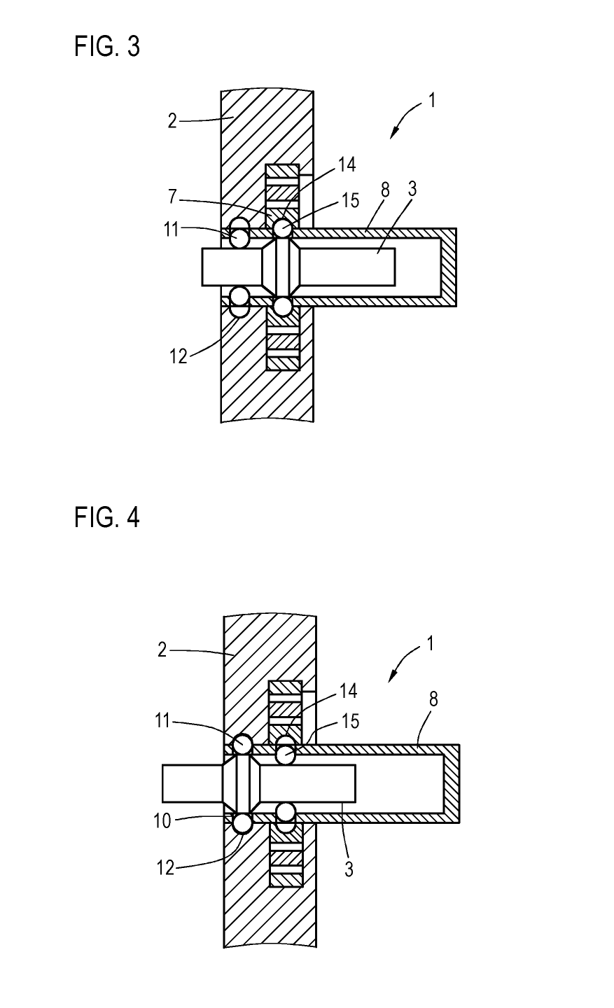

In the following text, reference will additionally be made to FIGS. 3 and 4 which show further operating states of the assembly 1. The assembly 1 comprises a linear cam mechanism having a shaft 3 which has a section 9 with an enlarged diameter. The transitions on both sides of the section 9 with an enlarged diameter are of wedge-shaped or conical configuration. The drive shaft 8 has recesses 10 for balls 11 which are supported on the shaft 3. In accordance with the recesses 10 in the drive shaft 8, recesses 12 are provided on the inner circumference of the belt pulley 2. The recesses 10 and the recesses 12 are situated at the same axial position. As shown in FIG. 1, a second row of balls 15 is provided which bear against the conical region of the drive shaft 8. Recesses 13 are provided in the drive shaft 8 at this axial position, and recesses 14 are situated in the sun gear 7 on the outer side of the recess 13.

FIG. 1 shows the assembly 1 in the disengaged state, with the result that no torque can be transmitted from the belt pulley 2 to the drive shaft 8.

If the belt pulley 2 is set in rotation by a belt, the planetary gears 6 are rotated by the external toothing system 5. However, the sun gear 7 is not set in rotation by the planetary gears 6, since the balls 15 are not situated in the recess 14 of the sun gear 7. The balls 11 are likewise not situated in the recess 12 of the belt pulley 2, with the result that there is no coupling of the belt pulley 2 to the drive shaft 8. The drive shaft 8 is at a standstill in the state which is shown in FIG. 1.

FIG. 3 shows an operating state, in which the shaft 3 of the linear cam mechanism has been displaced axially, starting from the view shown in FIG. 1 to the left. As a result, the balls 15 have been moved through the section 9 with an enlarged diameter of the shaft 3 in each case into a recess 14, with the result that they make contact firstly with the sun gear 7 and secondly with the drive shaft 8. In this way, the sun gear 7 is coupled to the drive shaft 8. In this state, the step-down transmission ratio is active, that is to say the drive shaft 8 rotates at a reduced rotational speed in comparison with the belt pulley 2. The rotational speed step-down transmission ratio between the drive shaft 8 and the planetary gears 6 corresponds to the ratio of the pitch circle diameters of the sun gear 7 and the external toothing system 5. The balls 11 are not situated within the recess 12, and the belt pulley 2 is correspondingly not coupled to the drive shaft 8. The state which is shown in FIG. 3 corresponds to normal operation of the assembly 1.

If an extreme load state is reached, for which the rotational speed step-down transmission ratio which is shown in FIG. 3 is not sufficient, the coupling between the drive shaft 8 and the sun gear 7 can be canceled and a direct coupling between the drive shaft 8 and the belt pulley 2 can be produced. To this end, the shaft 3 is displaced axially out of the position which is shown in FIG. 3 into the position which is shown in FIG. 4, to the left in the exemplary embodiment which is shown. It can be seen in FIG. 4 that the balls 15 have been displaced inwardly from the recesses 14, since they are no longer pressed to the outside by the section 9 with an enlarged diameter of the shaft 3. This section 9 then presses the balls 11 to the outside, however, with the result that they are situated partially in the recesses 12 of the belt pulley 2 and partially in the recesses 10 of the drive shaft 8. In this way, the drive shaft 8 is coupled directly to the belt pulley 2. If the belt pulley 2 is rotated by a belt, the shaft 3 is rotated at the same rotational speed as a result. The delivery output of the water pump is increased as a result of the increased rotational speed in comparison with the state which is shown in FIG. 3, with the result that the required increased cooling requirements can be met.

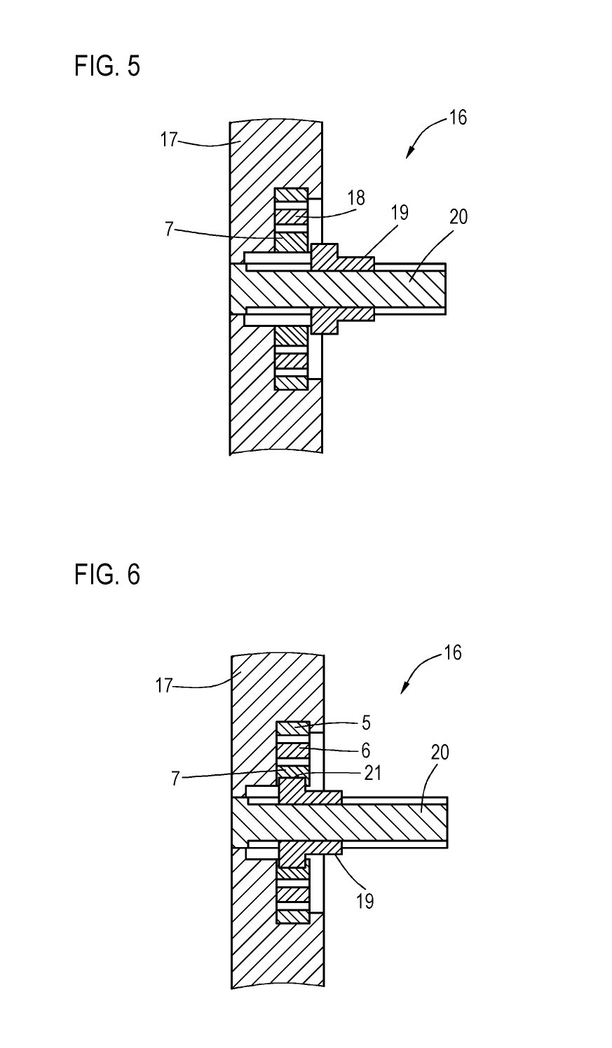

FIGS. 5 to 7 in each case show a second exemplary embodiment of an assembly. Components which coincide with those of the first exemplary embodiment are denoted by the same designations.

In conformity with the first exemplary embodiment, the assembly 16 comprises a belt pulley 17 having a planetary gear mechanism 18 and additionally a slider sleeve 19 which is arranged on a drive shaft 20 such that it can be moved axially but is fixed rotationally.

FIG. 5 shows the assembly 16 in the disengaged date. If the belt pulley 17 is rotated, the drive shaft 20 is at a standstill, since it is not coupled to the belt pulley 17. The assembly 16 is operated in this state when the drive shaft 20 is not to be driven. One example for this state is cold starting of an internal combustion engine. It is favorable to disengage the water pump during the warming-up phase.

FIG. 6 shows a state, in which the slider sleeve 19 has been displaced axially on the drive shaft 20, to the left in the view which is shown in FIG. 6.

The slider sleeve 19 comprises an elevated section 21 which engages into a corresponding opening of the sun gear 7, with the result that the slider sleeve 19 and the sun gear 7 are connected to one another in a positively locking manner. During a rotation of the belt pulley 17, said belt pulley 17 rotates the planetary gears 6 via its external toothing system 5, which planetary gears 6 are in turn in engagement with the outer circumference of the sun gear 7. As a result, the slider sleeve 19 is also set in rotation which is in turn connected fixedly to the drive shaft 20 so as to rotate with it. The slider sleeve 19 and the drive shaft 20 are connected to one another in a positively locking manner via a splined shaft geometry or a wedge-shaped toothing system. Accordingly, the drive shaft 20 is set in rotation, a step-down transmission ratio of the rotational speed being brought about by the planetary gear mechanism 18.

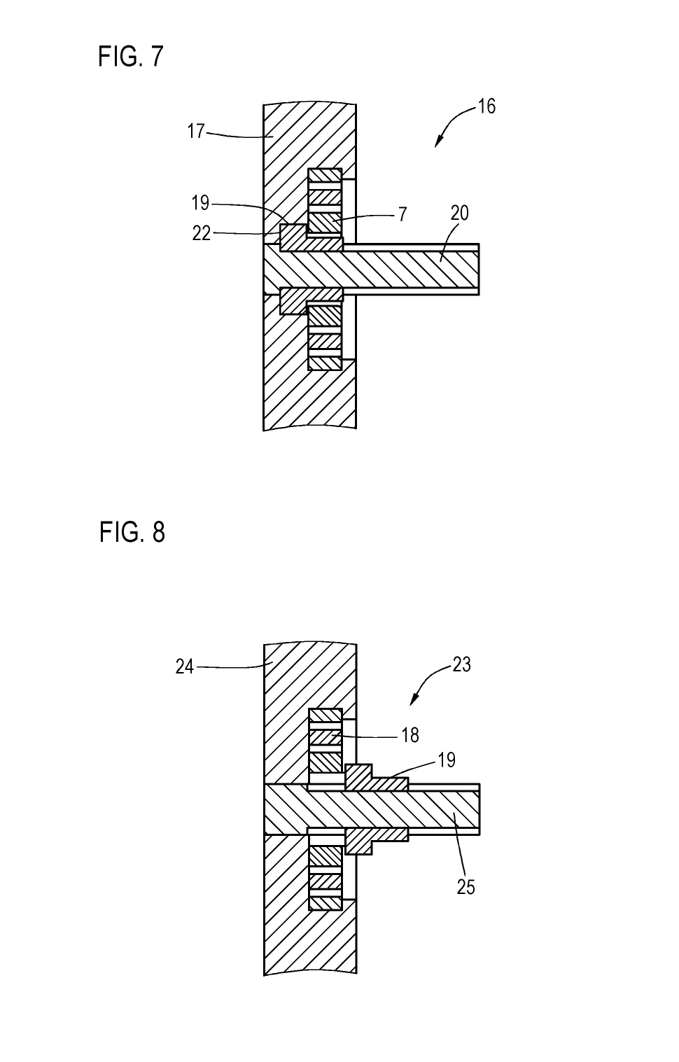

FIG. 7 shows an operating state, in which the slider sleeve 19 has been displaced axially further with respect to the belt pulley 17, until the elevated section 21 is no longer in engagement with the sun gear 7. The elevated section 21 is inserted into a corresponding recess 22, with the result that the belt pulley 17 and the drive shaft 20 are connected to one another fixedly by way of the slider sleeve 19 so as to rotate with one another. Accordingly, the drive shaft 20 is rotated at the same rotational speed as the belt pulley 17.

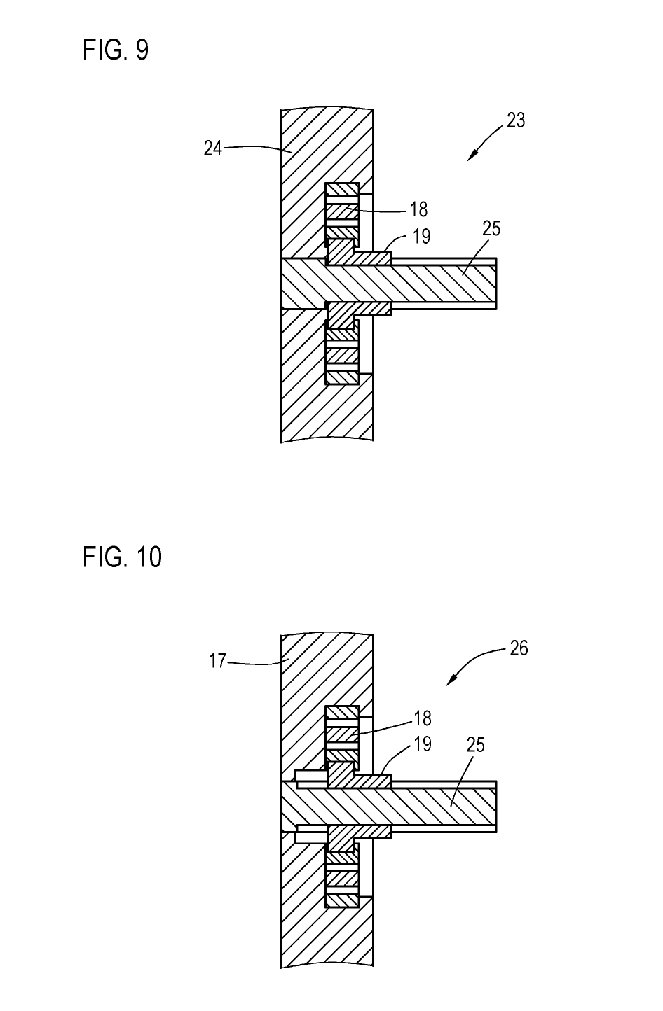

FIGS. 8 and 9 show a further exemplary embodiment of an assembly 23 which coincide substantially with the exemplary embodiment which is shown in FIGS. 5 to 7. Coinciding components and functions will therefore not be explained in detail again at this point. A belt pulley 24 has a planetary gear mechanism 18 which can be coupled or decoupled to/from a drive shaft 25 by means of a slider sleeve 19. In the configuration which is shown in FIG. 8, the belt pulley 24 is decoupled from the drive shaft 25, and the drive shaft 25 does not rotate. In the configuration which is shown in FIG. 9, the drive shaft 25 is set in rotation by the belt pulley with a step-down transmission ratio via planetary gear mechanisms 18. The assembly 23 which is shown in FIGS. 8 and 9 can therefore be considered to be a simplified embodiment of the assembly 16, direct coupling (as shown in FIG. 7) not being possible.

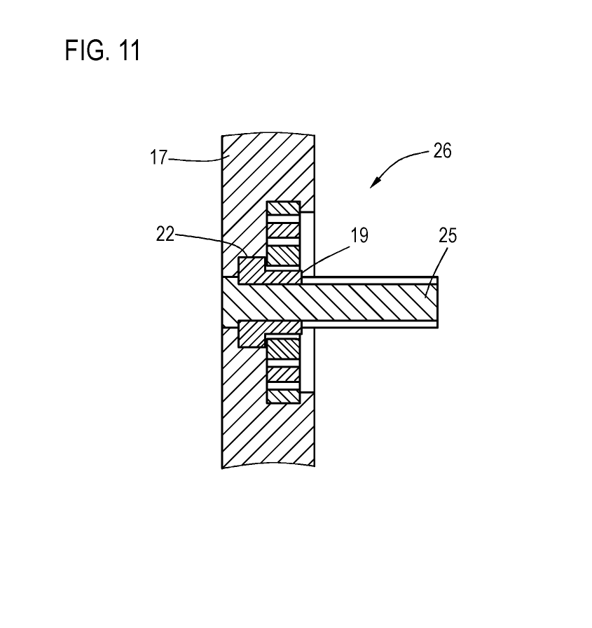

FIGS. 10 and 11 show a further exemplary embodiment of an assembly. The assembly 26 comprises the belt pulley 17, the planetary gear mechanism 18, and the shaft 25, on which the slider sleeve 19 is mounted such that it is fixed rotationally but can be displaced axially.

In the state which is shown in FIG. 10, the belt pulley 17 is connected via the planetary gear mechanism 18 to the slider sleeve 19, with the result that the drive shaft 25 is rotated during a rotation of the belt pulley 17, the rotational speed of the belt pulley 17 being stepped down.

FIG. 11 shows a similar state to FIG. 7, the slider sleeve 19 being inserted into the recess 22 of the belt pulley 17, with the result that the belt pulley 17 and the drive shaft 25 are connected to one another fixedly so as to rotate together. As a result of this rigid coupling, the drive shaft 25 is rotated at the same rotational speed as the belt pulley 17.

The actuation of the shaft 3 of the linear cam mechanism or the slider sleeve 19 takes place by means of an actuator.

### LIST OF DESIGNATIONS

1 Assembly
2 Belt pulley
3 Shaft
4 Planetary gear mechanism
5 External toothing system
6 Planetary gear
7 Sun gear
8 Drive shaft
9 Section
10 Recess
11 Ball
12 Recess
13 Recess
14 Recess
15 Ball
16 Assembly
17 Belt pulley
18 Planetary gear mechanism
19 Slider sleeve
20 Drive shaft
21 Section
22 Recess
23 Assembly
24 Belt pulley
25 Drive shaft
26 Assembly

1. An assembly having a belt-pulley drive, the belt-pulley drive comprising a belt pulley which is driven by a belt and is configured for transmitting a torque to a drive shaft of the assembly, and a switchable gear mechanism which makes a transmission ratio possible between a rotational speed of the belt pulley and a rotational speed of the drive shaft.

2. The assembly, as claimed in claim 1, wherein the belt-pulley drive is switchable and the assembly further comprises, a clutch which, in an engaged state, brings about a drive connection between the belt pulley and a drive shaft of the assembly and, in a non-engaged state, brings about a separation of the belt pulley from the drive shaft, and the switchable gear mechanism makes the transmission ratio possible between the rotational speed of the belt pulley and the rotational speed of the drive shaft.

3. The assembly as claimed in claim 1, wherein the switchable gear mechanism is a planetary gear mechanism.

4. The assembly as claimed in claim 3, wherein the belt pulley comprises an external toothing system which is in engagement with a plurality of planetary gears which in turn are engageable with a sun gear which is connected to the drive shaft.

5. The assembly as claimed in claim 4, further comprising a linear cam mechanism that enables a coupling of the drive shaft to the sun gear or the belt pulley.

6. The assembly as claimed in claim 5, wherein the linear cam mechanism comprises a section with an increased diameter, and via said section presses balls into recesses in a corresponding axial positioning, in order to produce a coupling between the belt pulley and the drive shaft or the planetary gear mechanism and the drive shaft.

7. The assembly as claimed in claim 4, further comprising a slider sleeve that enables a coupling of the drive shaft to the sun gear or the belt pulley.

8. The assembly as claimed in claim 5, wherein the linear cam mechanism is displaceable via an actuator.

9. The assembly as claimed in claim 1, wherein the assembly comprises a water pump, hydraulic pump, compressor or generator.

10. The assembly as claimed in claim 7, wherein the slider sleeve is displaceable via an actuator.
